(19) United States
(12) Patent Application Publication
(10) Pub. No.: US 2025/0068828 A1
(43) Pub. Date: Feb. 27, 2025

(54) METHOD, APPARATUS, ELECTRONIC DEVICE AND STORAGE MEDIUM FOR PROCESSING DATA

(71) Applicant: Beijing Volcano Engine Technology Co., Ltd., Beijing (CN)

(72) Inventors: Yuxuan He, Beijing (CN); Qian Ren, Beijing (CN)

(21) Appl. No.: 18/814,325

(22) Filed: Aug. 23, 2024

(30) Foreign Application Priority Data
Aug. 25, 2023 (CN) 202311085488.8

(51) Int. Cl. G06F 40/106

(52) U.S. Cl. CPC G06F 40/106

(57) ABSTRACT

The embodiment of the disclosure provides a data processing method, apparatus, electronic device and a storage medium. The method includes: displaying a data display page, the data display page comprising a data detail region and a data summary region, the data detail region comprising a plurality of data detail sub-regions; the data summary region comprising a plurality of data summary sub-regions; in response to selection of a target data detail sub-region, moving a data summary sub-region corresponding to the target data detail sub-region to a first target position, the first target position being a position corresponding to a position of the target data detail sub-region; and in response to selection of a target data summary sub-region, moving a data detail sub-region corresponding to the target data summary sub-region to a second target position, the second target position being a position corresponding to a position of the target data summary sub-region.

### CROSS-REFERENCE

The present application claims priority to Chinese Patent Application No. 202311085488.8, filed on Aug. 25, 2023 and entitled “METHOD, APPARATUS, ELECTRONIC DEVICE AND STORAGE MEDIUM FOR PROCESSING DATA”, the entirety of which is incorporated herein by reference.

### FIELD

Embodiments of the present disclosure relate to the field of computer technologies, and in particular, to a method, an apparatus, an electronic device, and a storage medium for processing data.

### BACKGROUND

Data exploration may be understood as a process of exploring source data. Before data analysis and developer use data, knowledge about the data may be improved through data exploration, such as understanding data structures, data content, data relationships, and possible problem of data, thereby enhancing quality of data.

In the prior art, data exploration can be carried out in a code writing mode, but the operation threshold of the method is high, and only professional personnel can realize; the result of data exploration may be displayed in a form of a table, but the data shown in the table is relatively complex, the information of each dimension of the data cannot be directly known from the table, the data exploration result cannot be clearly and visually displayed, and the feature of the data cannot be completely reflected.

### SUMMARY

According to the method, apparatus, electronic device and storage medium for processing data, the display form of the data exploration result is enriched, the data exploration result is clearly and visually displayed, and then the data feature is completely reflected.

According to a first aspect, a method for processing data is provided in accordance with an embodiment of this disclosure. The method comprises:
displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
in response to selection of a target data detail sub-region on the data display page, moving a data summary sub-region corresponding to the target data detail sub-region to a first target position, the first target position being a position on the data summary region, corresponding to a position of the target data detail sub-region; and
in response to selection of a target data summary sub-region on the data display page, moving a data detail sub-region corresponding to the target data summary sub-region to a second target position, the second target position being a position on the data detail region, corresponding to a position of the target data summary sub-region.

According to a second aspect, an apparatus for processing data is provided in accordance with an embodiment of this disclosure. The apparatus comprises:
a first display module configured to display a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
a second display module configured to, in response to selection of a target data detail sub-region on the data display page, move a data summary sub-region corresponding to the target data detail sub-region to a first target position, the first target position being a position on the data summary region, corresponding to a position of the target data detail sub-region; and
a third display module configured to, in response to selection of a target data summary sub-region on the data display page, move a data detail sub-region corresponding to the target data summary sub-region to a second target position, the second target position being a position on the data detail region, corresponding to a position of the target data summary sub-region.

According to a third aspect, an electronic device is provided in accordance with an embodiment of this disclosure. The electronic device comprises:
one or more processing devices;
a storage device storing one or more programs;
the one or more programs, when executed by the one or more processing devices, causing the one or more processing devices implement the method for processing data according to embodiments of this disclosure.

According to a fourth aspect, a storage medium comprising computer-executable instructions is provided in accordance with an embodiment of this disclosure, the computer-executable instructions, when executed by a computer processor, perform the method for processing data according to embodiments of this disclosure.

The embodiment of the disclosure provides a method, an apparatus, an electronic device and a storage medium for processing data. The method comprises: displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region; in response to selection of a target data detail sub-region on the data display page, moving a data summary sub-region corresponding to the target data detail sub-region to a first target position, the first target position being a position on the data summary region, corresponding to a position of the target data detail sub-region; and in response to selection of a target data summary sub-region on the data display page, moving a data detail sub-region corresponding to the target data summary sub-region to a second target position, the second target position being a position on the data detail region, corresponding to a position of the target data summary sub-region.

According to the technical scheme, the specific data is displayed through the data detail sub-region, the summary information of the data in the data detail sub-region is displayed through the data summary sub-region corresponding to the data detail sub-region. On one hand, detailed data display is reserved, and on the other hand, the summary of the data can be displayed. Meanwhile, through the selection of the target data detail sub-region or the target data summary sub-region, the linkage of the positioning of the data detail sub-region and the data summary sub-region is realized. The corresponding data summary sub-region can be quickly positioned to display through the data detail sub-region, or the corresponding data detail sub-region can be quickly positioned to display through the data summary sub-region. The display form of the data exploration result is enriched, the result of data exploration is clearly and visually displayed, and then the feature of the data is completely reflected.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method for processing data according to an embodiment of the present disclosure;

FIG. 2 is a schematic diagram of a data display page according to an embodiment of the present disclosure;

FIG. 3 is a schematic diagram of another data display page according to an embodiment of the present disclosure;

FIG. 4 is a schematic diagram of still another data display page according to an embodiment of the present disclosure;

FIG. 5 is a schematic flowchart of another method for processing data according to an embodiment of the present disclosure;

FIG. 6 is a schematic diagram of a target data summary sub-region according to an embodiment of the present disclosure;

FIG. 7 is a schematic diagram of still another data display page according to an embodiment of the present disclosure;

FIG. 8 is a schematic diagram of adjusting size of a data summary sub-region according to an embodiment of the present disclosure;

FIG. 9 is a schematic diagram of a data sampling selection page according to an embodiment of the present disclosure;

FIG. 10 is a schematic diagram of a data summary sub-region according to an embodiment of the present disclosure;

FIG. 11 is a schematic diagram of another data display page according to an embodiment of the present disclosure;

FIG. 12 is a schematic diagram of still another data display page according to an embodiment of the present disclosure;

FIG. 13 is a schematic diagram of a group setting window according to an embodiment of the present disclosure;

FIG. 14 is a schematic structural diagram of an apparatus for processing data according to an embodiment of the present disclosure; and

FIG. 15 is a schematic structural diagram of an electronic device according to an embodiment of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in different order and/or in parallel. Furthermore, method implementations may include additional steps and/or omit steps that are shown. The scope of the present disclosure is not limited in this regard.

The terms “comprise” and its variants used herein are to be read as open terms that mean “include, but is not limited to.” The term “based on” is to be read as “based at least in part on.” The term “one embodiment” is to be read as “at least one embodiment,” the term “another embodiment” is to be read as “at least one another embodiment,” and the term “some embodiments” is to be read as “at least some embodiments.” Other definitions, explicit and implicit, might be included below.

It should be noted that the concepts of “first,” “second” and the like mentioned in the present disclosure are only used to distinguish between different apparatuses, modules or units, rather than limiting the order or interdependence of the functions performed by these apparatuses, modules or units.

It should be noted that modifications “one” and “more” mentioned in the present disclosure are examples but not limiting, and should be understood as “one or more” to those skilled in the art unless otherwise specified.

Names of messages or information exchanged between the plurality of apparatuses in implementations of the present disclosure are used for illustrative purposes only and are not intended to limit the scope of those messages or information.

It can be understood that before using the technical solutions disclosed in the embodiments of the present disclosure, relevant user should be informed of the types, use ranges, usage scenarios, and the like of the information related to the present disclosure in an appropriate manner according to relevant laws and regulations, and the authorization of the related user may be obtained.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information, such as an electronic device, application program or storage medium.

As an optional but non-limiting implementation, in response to receiving the active request of the user, the manner of sending the prompt information to the user may be, for example, a pop-up window, and the prompt information may be displayed in text in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

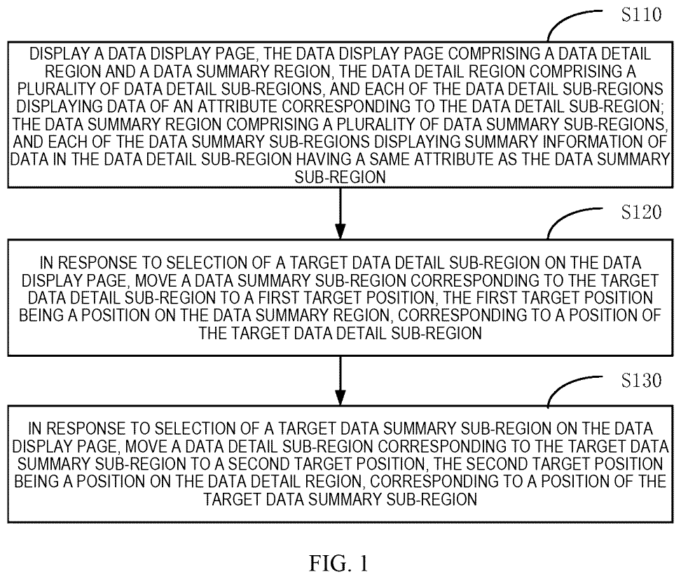

FIG. 1 is a schematic flowchart of a method for processing data according to an embodiment of the present disclosure. The embodiments of this disclosure is applicable to the situation of displaying the results of data exploration., and the method can be executed by a data processing device, which can be implemented in the form of software and/or hardware and integrated into an electronic device. Optionally, the electronic device can be a mobile terminal or a PC terminal, etc. Optionally, the electronic device may be a mobile terminal or a PC terminal.

As shown in FIG. 1, the method includes:

S110: display a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region.

The data display page may be a page for displaying data, such as a page for displaying results of data exploration. The data involved in the data display page may be data obtained by sampling the database according to actual needs. The sampling strategy is not limited, for example, it may be continuous sampling, random sampling or filtering sampling. The continuous sampling is used for retrieving continuous data from a database; the filtering sampling is used for retrieving data from a database according to a filtering condition, and the filtering condition may be a condition for filtering data, which is not limited herein; and random sampling is used for randomly retrieving data from a database.

The data display page comprises a data detail region and a data summary region. The data detail region may be a region for displaying detail of the data, and data may be displayed in the form of a table in the data detail region. The data summary region may be a region for presenting a summary of the data, in which the summary of the data displayed in the data detail region may be displayed in the form of a card. The data detail region and the data summary region may be arranged up and down or left and right in the data display page, which is not limited herein.

The data detail region comprises a plurality of data detail sub-regions, and the data summary region comprises a plurality of data summary sub-regions.

Each of the data detail sub-regions is configured to display data of an attribute corresponding to the data detail sub-region. For example, for any data detail sub-region, the data detail sub-region may be understood as a column in a table, an attribute corresponding to the data detail sub-region may be understood as a field name corresponding to the column, and data in the data detail sub-region is data included in the column. The field may refer to a column in a table, that is, a data set having a same attribute, and a name of each field is a field name.

Each of the data summary sub-regions is configured to display summary information of data in the data detail sub-region having a same attribute as the data summary sub-region. For any data summary sub-region, the data summary sub-region may be understood as one of a plurality of cards in the data summary region. The data summary sub-region has a unique data detail sub-region corresponding to the data summary sub-region, and the data summary sub-region and the corresponding data detail sub-region have the same attribute, that is, the data displayed by both belong to data corresponding to the same field name.

For example, the data corresponding to the field name may be displayed in a corresponding data detail sub-region, and the summary information of the data corresponding to the field name may be displayed in the data summary sub-region. The summary information may be information for summarizing the data of the data detail sub-region corresponding to the data summary sub-region through a plurality of dimensions.

In an embodiment, the summary information indicates a dimension of a summary comprising at least one of:
a zero value in the data, a null value in the data, an enumerated value in the data, or a statistical result of the data.

For any data summary sub-region, the zero value in the data may be data of zero in the data of the corresponding data detail sub-region; the null value in the data may be no value; the enumerated value in the data may be data having a difference in the data; the statistical result of the data may include, but is not limited to, a minimum value, a maximum value, a quantile, a sum, or a standard deviation of the data.

In any data summary sub-region, the manner of displaying the summary information is not limited. The summary information may be displayed in the form of text or histogram.

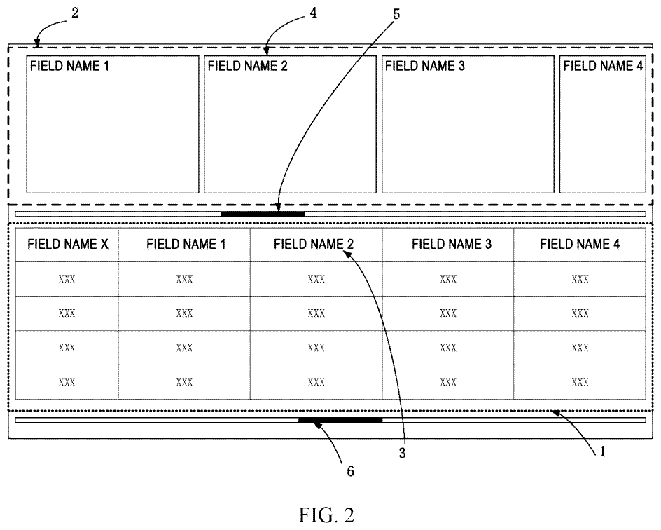

FIG. 2 is a schematic diagram of a data display page according to an embodiment of the present disclosure. As shown in FIG. 2, the data display page comprises a data detail region 1 and a data summary region 2. The data detail region 1 comprises a plurality of data detail sub-regions, and each of data detail sub-regions may be understood as a column in a table, for example, a column corresponding to field name 1, field name 2 (that is, a data detail sub-region 3), field name 3, or field name 4 in a table. The data summary region 2 comprises a plurality of data summary sub-regions, which may be understood as one of a plurality of cards in the data summary region 2, such as a card corresponding to field name 1, field name 2 (i.e., the data summary sub-region 4), field name 3, or field name 4.

For example, the data corresponding to the field name 2 may be displayed in the data detail sub-region 3, and the summary information of the data corresponding to the field name 2 may be displayed through the data summary sub-region 4 corresponding to the data detail sub-region 3.

In this embodiment of the present disclosure, the plurality of data summary sub-regions may be browsed by triggering left-right sliding of the first control 5 shown in FIG. 2; and the plurality of data detail sub-regions may be browsed by triggering the left-right sliding of the second control 6 shown in FIG. 2. When the plurality of data summary sub-regions are browsed in the horizontal direction, the display positions of the plurality of data detail sub-regions may remain unchanged; correspondingly, when the plurality of data detail sub-regions are browsed in the horizontal direction, the display positions of the plurality of data detail sub-regions may remain unchanged.

S120: in response to selection of a target data detail sub-region on the data display page, move a data summary sub-region corresponding to the target data detail sub-region to a first target position, the first target position is a position on the data summary region, corresponding to a position of the target data detail sub-region.

The selection of the target data detail sub-region may be selection of one of the plurality of data detail sub-regions included in the data detail region, and the selected data detail sub-region is the target data detail sub-region. The selection of one of the data detail sub-regions may be a click by the user on a field name in one of the data detail sub-regions, which is not limited herein.

The first target position may be a position to which the data summary sub-region corresponding to the target data detail sub-region is moved by the selection of the target data detail sub-region.

The first target position is a position on the data summary region, corresponding to a position of the target data detail sub-region. For example, the first target position is a position on the data summary region, where an extension line of the symmetry axis of the target data detail sub-region is located. The symmetry axis of the target data detail sub-region may be perpendicular to the direction in which the data summary sub-region moves.

In response to the selection of the target data detail sub-region on the data display page, moving the data summary sub-region corresponding to the target data detail sub-region to the first target position may be read as: in response to click of a field name in the target data detail sub-region on the data display page, moving a data summary sub-region corresponding to the target data detail sub-region to the first target position. When the corresponding data summary sub-region moves to the first target position, the moved data summary sub-region coincides with the symmetry axis of the target data detail sub-region, and the symmetry axis is perpendicular to the moving direction of the data summary sub-region.

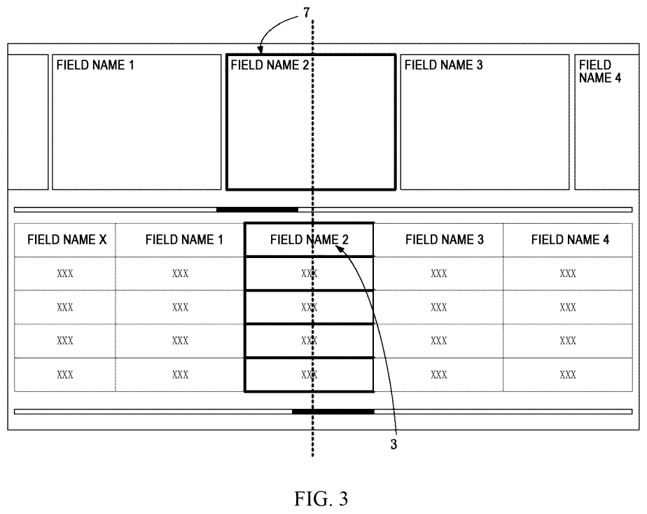

FIG. 3 is a schematic diagram of another data display page according to an embodiment of the present disclosure, and step S120 is exemplarily described in conjunction with FIG. 2 and FIG. 3.

In response to the click on the field name 2 in the target data detail sub-region 3 on the data display page shown in FIG. 2, the data summary sub-region 4 corresponding to the target data detail sub-region 3 is moved to the first target position. The first target position is the position displayed by the data summary sub-region 7 on the data display page shown in FIG. 3. As shown in FIG. 3, the data summary sub-region 7 coincides with the symmetry axis of the target data detail sub-region 3, and the symmetry axis is perpendicular to the direction in which the data summary sub-region moves.

S130: in response to selection of a target data summary sub-region on the data display page, moving a data detail sub-region corresponding to the target data summary sub-region to a second target position, the second target position is a position on the data detail region, corresponding to a position of the target data summary sub-region.

The selection of the target data summary sub-region may be a selection of one of the plurality of data summary sub-regions included in the data summary region, and the selected data summary sub-region is the target data summary sub-region. The selection of one of the data summary sub-regions may be a click by the user at any position of one of the data summary sub-regions, which is not limited herein.

The second target position may be a position to which the data detail sub-region corresponding to the target data summary sub-region is moved by the selection of the target data summary sub-region.

The second target position is a position on the data detail region, corresponding to the target data summary sub-region. For example, the second target position is a position on the data detail region, where an extension line of the symmetry axis of the target data summary sub-region is located. The symmetry axis of the target data summary sub-region may be perpendicular to the direction in which the data detail sub-region moves.

In response to the selection of the target data summary sub-region on the data display page, moving the data detail sub-region corresponding to the target data summary sub-region to the second target position may be read as: in response to click of any position in the target data summary sub-region on the data display page, moving a data detail sub-region corresponding to the target data summary sub-region to the second target position. When the corresponding data detail sub-region moves to the second target position, the moved data detail sub-region coincides with the symmetry axis of the target data summary sub-region, and the symmetry axis is perpendicular to the moving direction of the data detail sub-region.

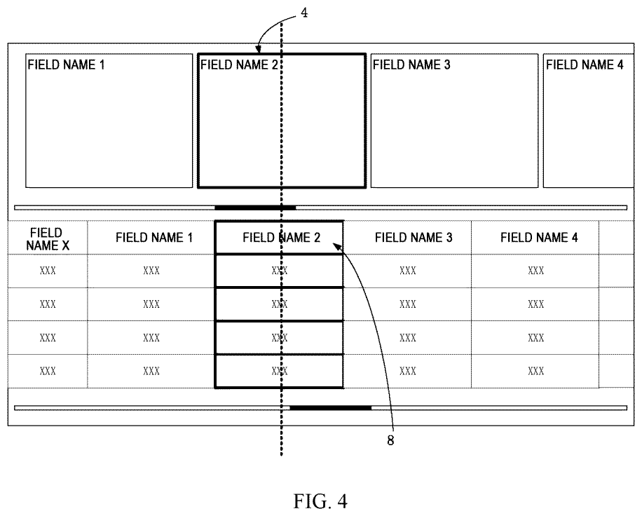

FIG. 4 is a schematic diagram of still another data display page according to an embodiment of the present disclosure, and step S130 is exemplarily described in conjunction with FIG. 2 and FIG. 4.

In response to a click on any position of the target data summary sub-region 4 on the data display page shown in FIG. 2, the data detail sub-region 3 corresponding to the target data summary sub-region 4 is moved to the second target position. The second target position is the position displayed by the data detail sub-region 8 on the data display page shown in FIG. 4. As shown in FIG. 4, the data detail sub-region 8 coincides with the symmetry axis of the target data summary sub-region 4, and the symmetry axis is perpendicular to the direction in which the data detail sub-region moves.

It should be noted that the execution order of steps S120 and S130 is not limited. S120 is performed in response to a selection of the target data detail sub-region on the data display page. S130 is performed in response to a selection of the target data summary sub-region on the data display page.

According to the technical scheme of the embodiment of the invention, the specific data is displayed through the data detail sub-region, the summary information of the data in the data detail sub-region is displayed through the data summary sub-region corresponding to the data detail sub-region. On one hand, detailed data display is reserved, and on the other hand, the summary of the data can be displayed. Meanwhile, through the selection of the target data detail sub-region or the target data summary sub-region, the linkage of the positioning of the data detail sub-region and the data summary sub-region is realized. The corresponding data summary sub-region can be quickly positioned to display through the data detail sub-region, or the corresponding data detail sub-region can be quickly positioned to display through the data summary sub-region. The display form of the data exploration result is enriched, the result of data exploration is clearly and visually displayed, and then the feature of the data is completely reflected.

Based on the foregoing embodiments, a variant embodiment of the foregoing embodiment is provided, and it should be noted that, to simplify the description, only the differences from the foregoing embodiments are described in the variant embodiments.

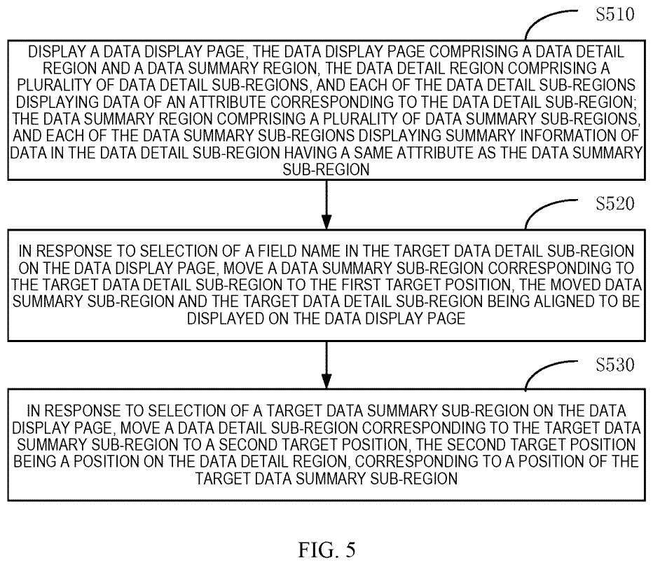

FIG. 5 is a schematic flowchart of another method for processing data according to an embodiment of the present disclosure. This disclosed embodiment is a further refinement based on the above embodiment, which moves to display the data summary sub-region corresponding to the target data detail sub-region to the first target position in response to the selection of the target data detail sub-region on the data display page.

As shown in FIG. 5, the method comprises:

S510: display a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region.

S520: in response to selection of a field name in the target data detail sub-region on the data display page, moving a data summary sub-region corresponding to the target data detail sub-region to the first target position, the moved data summary sub-region and the target data detail sub-region being aligned to be displayed on the data display page.

The data in the data detail region is displayed in a form of a table, and the attribute to which the data belongs is a field of a table. This embodiment does not limit the manner of the alignment display, as long as the moved data summary sub-region and the target data detail sub-region are convenient to be displayed at the same time. For example, one side of the two sub-regions is aligned, and for another example, a symmetry axis of the two sub-regions is aligned.

Steps S520 are described in conjunction with FIG. 2 and FIG. 3.

In response to the click on the cell where the field name 2 in the target data detail sub-region 3 is located on the data display page shown in FIG. 2, the data summary sub-region 4 corresponding to the target data detail sub-region 3 is moved to the first target position. The first target position is the position displayed by the data summary sub-region 7 on the data display page shown in FIG. 3. As shown in FIG. 3, the data summary sub-region 7 (i.e., the moved data summary sub-region) and the target data detail sub-region 3 are aligned to be displayed on the data display page.

S530: in response to selection of a target data summary sub-region on the data display page, move a data detail sub-region corresponding to the target data summary sub-region to a second target position, the second target position being a position on the data detail region, corresponding to a position of the target data summary sub-region.

In one embodiment, the target data summary sub-region in the data summary region is displayed in the form of a card, and the moved data detail sub-region and the target data summary sub-region are aligned to be displayed on the data display page.

The above embodiments are described with reference to FIG. 2 and FIG. 4.

In response to a click on any position of the target data summary sub-region 4 on the data display page shown in FIG. 2, the data detail sub-region 3 corresponding to the target data summary sub-region 4 is moved to the second target position. The second target position is the position displayed by the data detail sub-region 8 on the data display page shown in FIG. 4. As shown in FIG. 4, the data detail sub-region 8 (that is, the moved data detail sub-region) and the target data summary sub-region 4 are aligned to be displayed on the data display page.

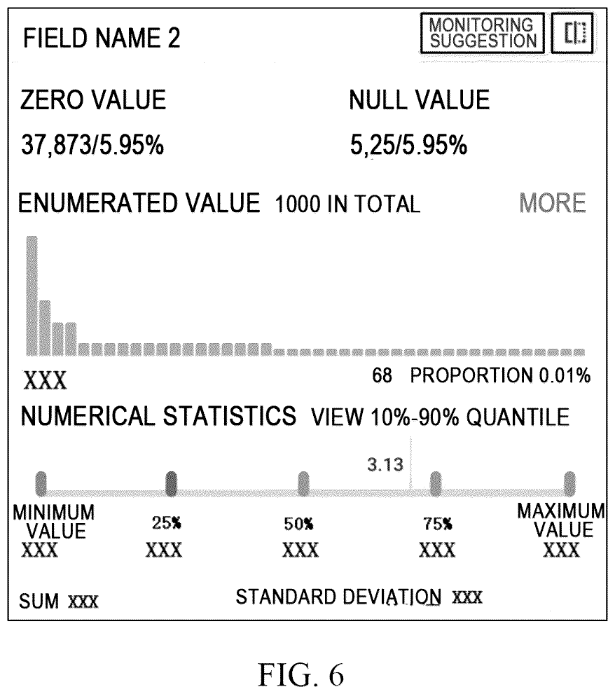

FIG. 6 is a schematic diagram of a target data summary sub-region according to an embodiment of the present disclosure. The schematic diagram of the target data summary sub-region shown in FIG. 6 is an enlarged view of the target data summary sub-region 4 shown in FIG. 2.

As shown in FIG. 6, the target data summary sub-region is displayed in a form of a card, and a field name (i.e., field name 2) and summary information of data corresponding to the field name 2 are displayed in the card. The manner of displaying the summary information is not limited. For example, for a zero value in the data and a null value in the data, the quantity and a proportion of the quantity in a total quantity of the data may be displayed in a form of a text; for an enumerated value in the data, a quantity of each enumerated value and a proportion of the quantity in a total quantity of data may be displayed in a form of a histogram; and a statistical result (that is, numerical statistics shown in FIG. 6) on the data may be displayed in a form of a histogram or a text, which is not limited herein.

According to the technical scheme provided by the embodiment of the invention, the specific data is displayed through the data detail sub-region. Meanwhile, through the data summary sub-region corresponding to the data detail sub-region, the summary information of the data in the data detail sub-region is displayed in the form of the card through multiple dimension such as a zero value in the data, the null value in the data, the enumerated value in the data and the statistical result of the data, so that the summary of the data is displayed from the multi-dimensional while the complete data is displayed, and the feature of the data can be completely reflected. Further, the target data detail sub-region and the corresponding data summary sub-region can be aligned to be displayed in response to the selection of the field name in the target data detail sub-region; the target data summary sub-region and the corresponding data detail sub-region can be aligned to be displayed in response to the selection of the card of the target data summary sub-region; quick linkage of the positioning of the data detail sub-region and the data summary sub-region is realized, and the display form of the data exploration result is enriched.

In an embodiment, the method for processing data further comprises:
in response to switching of the data summary sub-region within the data summary region, switching the displayed data summary sub-region within the data summary region, a display position of the data detail sub-region displayed within the data detail region being unchanged; and
in response to switching of the data detail sub-region within the data detail region, switching the displayed data detail sub-region in the data detail region, a display position of the data summary sub-region displayed in the data detail region being unchanged.

The switching of the data summary sub-region may be switching of the data summary sub-region displayed in the data summary region. The switching of the data detail sub-region may be switching of the data detail sub-region displayed in the data detail region.

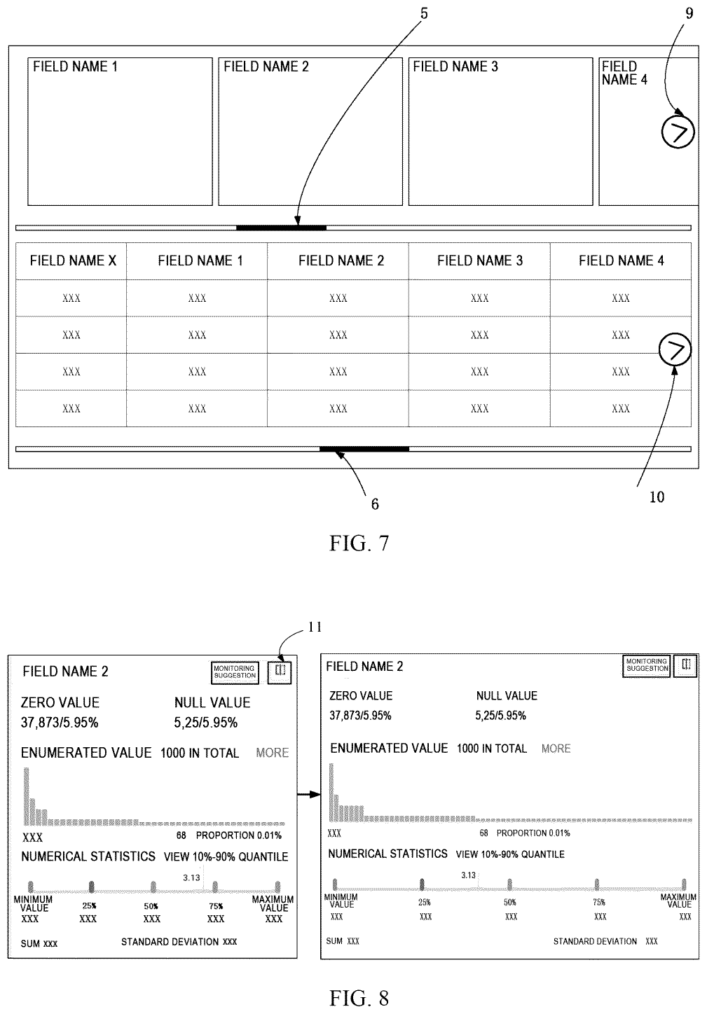

FIG. 7 is a schematic diagram of still another data display page according to an embodiment of the present disclosure, the switching is described with reference to FIG. 7.

The displayed data summary sub-region is switched within the data summary region. As shown in FIG. 7, the plurality of data summary sub-regions may be browsed by triggering left-right sliding of the first control 5; or a plurality of data summary sub-regions may be browsed by triggering left-right sliding of the third control 9. When the displayed data summary sub-region is switched, the display position of the data detail sub-region displayed in the data detail region is unchanged, that is, the switching display of the data summary sub-region does not affect the display of the data detail sub-region.

The displayed data detail sub-region is switched within the data detail region. As shown in FIG. 7, the plurality of data detail sub-regions may be browsed by triggering left-right sliding of the second control 6; or a plurality of data detail sub-regions may be browsed by triggering left-right sliding of the fourth control 10. When the displayed data detail sub-region is switched, the display position of the data summary sub-region displayed in the data summary region is unchanged, that is, the switching display of the data detail sub-region does not affect the display of the data summary sub-region.

In an embodiment, a region width of the data summary sub-region along a moving direction is greater than a region width of the data detail sub-region along a moving direction, and the moving direction of the data summary sub-region is the same as the moving direction of the data detail sub-region.

The moving direction of the data summary sub-region may be a left-right slide indicated by the switching operation. The moving direction of the data detail sub-region may be a left-right slide indicated by the switching operation, and a moving direction of the data summary sub-region and a moving direction of the data detail sub-region are both lateral movements.

When the data summary region and the data detail region are arranged left and right, the plurality of data summary sub-regions may be distributed up and down in the data summary region, and the plurality of data detail sub-regions may be distributed up and down in the data detail region (that is, each horizontal row of the table corresponds to data which corresponds to one field name). In this case, both the moving direction of the data summary sub-region and the moving direction of the data detail sub-region may be longitudinal movement.

In an embodiment, the method for processing data comprises:
in response to an adjusting operation on a size of the data summary sub-region, adjusting the size of the data summary sub-region.

The resizing operation may be an operation to adjust the size displayed by the data summary sub-region.

In the data summary sub-region, a widening control may be displayed for laterally widening the size of the data summary sub-region. In response to a click on the widening control, the size of the data summary sub-region may be widened laterally.

In the data summary sub-region, a heightening control may be displayed for longitudinal heightening of the size of the data summary sub-region. In response to a click on the heightening control, the size of the data summary sub-region may be increased longitudinally.

In the data summary sub-region, an amplification control may be displayed, and the amplification control is configured to magnify the display data summary sub-region. In response to a click on the amplification control, the display data summary sub-region may be enlarged, such as enlarging the display data summary sub-region in the form of a floating window or the like.

The click on the widening control, the click on the heightening control, and the click on the amplification control may be understood as the size adjustment operation.

In an embodiment, in response to the adjusting operation on the size of the data summary sub-region, adjusting the size of the data summary sub-region comprises:
in response to the adjustment operation on the size of the data summary sub-region, adjusting a region width of the data summary sub-region along a moving direction of the data summary sub-region.

The region width may be the width of the data summary sub-region along the moving direction, such as when the moving direction of the data summary sub-region is lateral, the region width may be the lateral width of the data summary sub-region.

FIG. 8 is a schematic diagram of adjusting size of a data summary sub-region according to an embodiment of the present disclosure. As shown in FIG. 8, in response to the adjustment operation on the size of the data summary sub-region, adjusting the region width of the data summary sub-region may be: in response to the click on the widening control 11 in the data summary sub-region on the left, laterally widening the size of the data summary sub-region, the widened data summary sub-region is the data summary sub-region shown on the right side of FIG. 8. The summary information displayed on the widened data summary sub-region may be adjusted in the widened direction, the displayed content may be the size of the display. As will be shown in the histogram, the enumerated value may be amplified in the widened direction.

In an embodiment, the method for processing data further comprises:
in response to selection of a sampling range on a data sampling selection page, sampling data in a database according to a selected sampling range, to obtain data displayed in the data display page.

The data sampling selection page may be a page for selecting a sampling range. The sampling range may be a range of data sampling from a database, such as continuous sampling, filtering sampling, and random sampling. The selection operation may be considered an operation to select a sampling range.

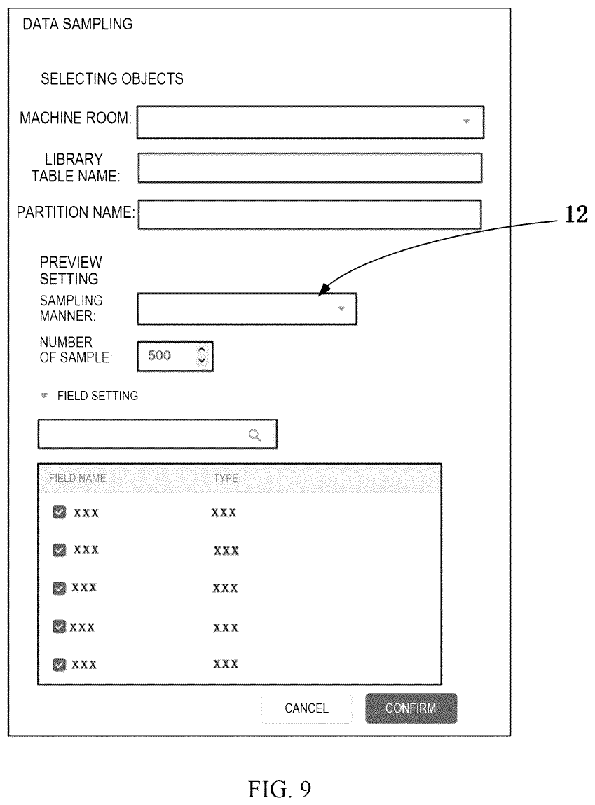

FIG. 9 is a schematic diagram of a data sampling selection page according to an embodiment of the present disclosure. As shown in FIG. 9, a pull-down control 12 for selecting a sampling range may be provided on the data sampling selection page. The different sampling ranges may be pulled down for selection in response to a click on the pull-down control 12. In response to a click on the pull-down expanded sampling range, the selected sampling range may be determined (the series of operations may be considered as a selection operation on the sampling range), and the data in the database of the selected sampling range is sampled to obtain the data displayed in the data display page.

As shown in FIG. 9, the data sampling selection page may also be displayed with a control for selecting or inputting a machine room (that is, a machine room where data that needs to be probed), a library table name (that is, a name of a database and a table in which the data that needs to be probed), and a partition name (that is, a name of a partition where the data that needs to be explored). A control for setting the number of samples may also be displayed on the data sampling selection page for setting the number of data samples. A control for field setting may be further displayed on the data sampling selection page, and is configured to search through a search box or screen a field that needs attention by checking.

In one embodiment, the sampling range comprises: continuous sampling, filtering sampling and random sampling;
the continuous sampling is configured to retrieve continuous data from the database;
the filtering sampling is configured to retrieve data from the database according to a filter condition; and
the random sampling is configured to randomly retrieve data from the database.

The successive sampling is used to retrieve successive data samples from a data set stored in a database.

The filtering samples are used to retrieve non-consecutive data samples from the database according to filter conditions. The filter condition may be a condition for filtering data, for example, a value in a certain field is greater than a set threshold, which is not limited herein.

The random sampling is used to randomly retrieve consecutive data samples from a database, and there is no specific rule when retrieving the data samples.

In an embodiment, each of the data summary sub-regions comprises a suggestion control, and the method further comprises:
in response to triggering on a target suggestion control, displaying a suggestion window, subsequent suggestion information on the data corresponding to the data summary sub-region where the target suggestion control is located being displayed on the suggestion window; and
in response to triggering of a configuration control on the suggestion window, implementing a suggestion indicated by the subsequent suggestion information.

The triggering on the target suggestion control may be an operation of triggering a suggestion control in one of the plurality of data summary sub-regions included in the data summary region, and the triggered suggestion control is the target suggestion control.

Displaying a suggestion window in response to the triggering on the target suggestion control may be: displaying the suggestion window in response to a click on the target suggestion control. The suggestion window may be a window for displaying subsequent suggestion information, and subsequent suggestion information may be displayed in a text form in the suggestion window.

The subsequent suggestion information may be the monitoring suggestion of the data corresponding to the data summary sub-region where the target suggestion control is located, for example, based on the data corresponding to the current data summary sub-region, the monitoring suggestion for subsequent data that has the same attribute of the part of data needs to be generated based on the actual application, so as to timely monitor the problem that the data may exist, thereby enhancing the quality of the data.

A configuration control may be displayed on the suggestion window, and the configuration control is configured to trigger implementation of the suggestion indicated by the subsequent suggestion information. In response to a click on the configuration control on the suggestion window, the suggestion indicated by the subsequent suggestion information may be performed.

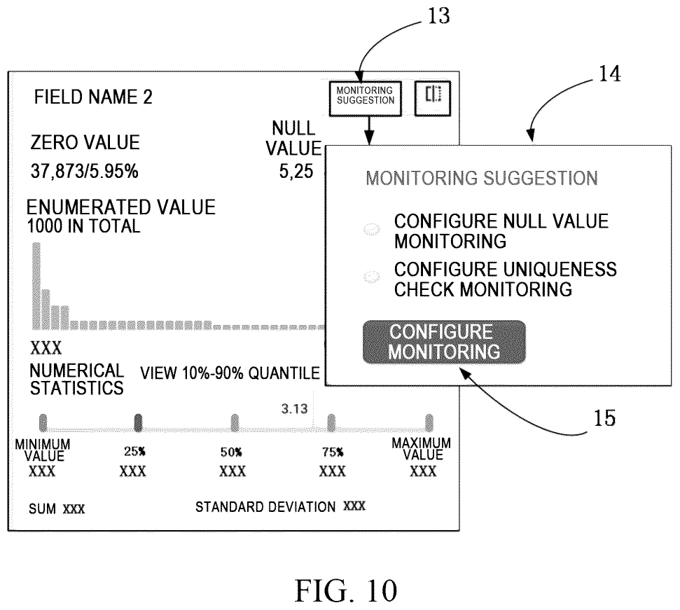

FIG. 10 is a schematic diagram of a data summary sub-region according to an embodiment of the present disclosure. As shown in FIG. 10, in response to a triggering on the target suggestion control 13 (that is, the monitoring suggestion), a suggestion window 14 may be displayed, and subsequent suggestion information of the data corresponding to the data summary sub-region is displayed on the suggestion window. The subsequent suggestion information indicates that Null value (i.e., empty value) monitoring needs to be configured, and uniqueness check monitoring needs to be configured.

A configuration control 15 (i.e., configuration monitoring) may be displayed on the suggestion window 14, Null value monitoring may be configured in response to a click on the configuration control 15 on the suggestion window 14, and uniqueness check monitoring may be configured.

In an embodiment, the method for processing data further comprises:
in response to triggering on a hiding control on the data display page, hiding the data summary area on the data display page; and
in response to triggering on a display control on the data display page, displaying the hidden data summary area on the data display page.

The hiding control may be considered as a control that triggers the data summary region to be hiden in the data display page. The display control may be considered as a control for triggering display of the data summary region in the data display page.

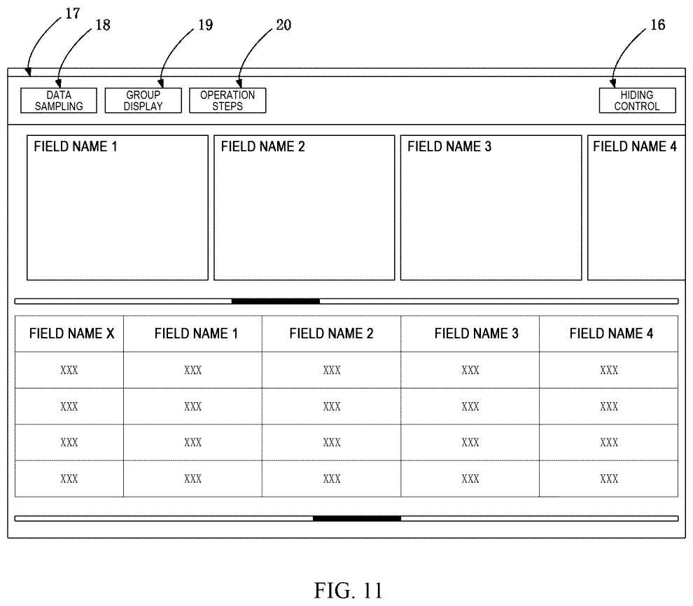

FIG. 11 is a schematic diagram of still another data display page according to an embodiment of the present disclosure. As shown in FIG. 11, a hiding control 16 is displayed on the data display page, and the data summary region is hidden on the data display page in response to a triggering of the hiding control 16.

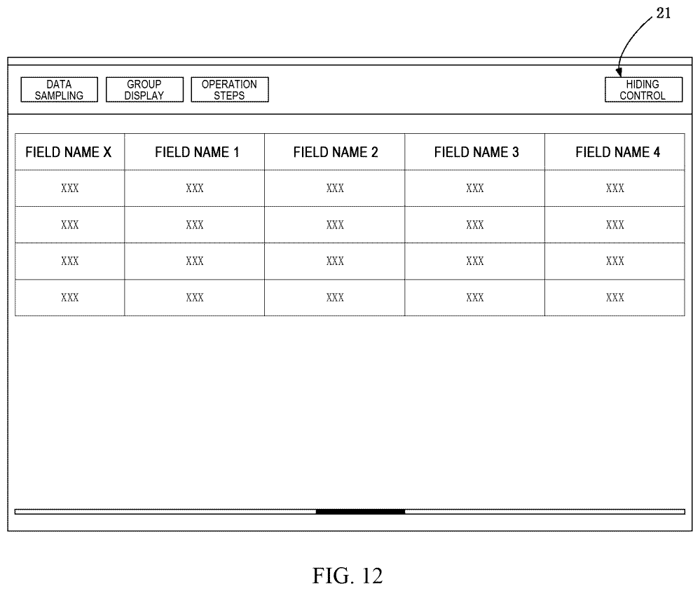

FIG. 12 is a schematic diagram of still another data display page according to an embodiment of the present disclosure, and the data display page shown in FIG. 12 may be understood as updating the displayed page after the hiding control 16 shown in FIG. 11 is triggered, and the data summary region in FIG. 12 is hidden. The hiding control 16 is a control for hiding the data summary region on the data display page.

As shown in FIG. 12, a position of the hiding control 16 is displayed in FIG. 11, a display control 21 is correspondingly displayed, and the display control 21 is a control for displaying the hidden data summary region. In response to the triggering of the display control 21, the data summary region is displayed on the data display page, that is, by triggering the display control 21 shown in FIG. 12, the data display page displayed in the display data summary region shown in FIG. 11 may be updated.

In an embodiment, the data display page comprises:
a query region configured to adjust display states of the data summary area and the data detail area.

The display state may be considered a state related to display. For example, by the group display control 19 shown in FIG. 11, the data in the data detail region is adjusted to be centrally displayed or separately displayed with a grouping granularity. For another example, the data sampling control 18 adjusts the data displayed in the data detail region is which part in the database. As another example, whether the data summary region is displayed is adjusted by the hiding control 16.

The query region is used to adjust a display state of the data summary region and the data detail region. As shown in FIG. 11, a query region 17 is included in the data display page, a plurality of controls are included in the query region 17, for example, a data sampling control 18, a group display control 19, an operation step control 20, and a hiding control 16. The display states of the data summary region and the data detail region may be adjusted by triggering a plurality of controls.

For example, the displayed data summary region may be hidden by triggering of the hiding control 16. By triggering the data sampling control 18, the data sampling selection page may be displayed, and the obtained re-sampled data is used to update the content displayed in the data summary region and the data detail region. By triggering the group display control 19, a window for setting the group display may be displayed on the right side of the data display page. By triggering the operation step control 20, the operation steps for the data display page may be displayed on the right side of the data display page.

It should be noted that the control included in the query region 17 shown in FIG. 11 is only a partially exemplary control, and in practical applications, other control capable of adjusting the display state of the data summary region and the data detail region may be included, for example, a control for performing data filtering, a control for performing column deletion, and a control for performing column sorting, which is not limited herein.

In an embodiment, the method for processing data further comprises:
in response to triggering on an operation step control in the query region, displaying an operation step for the data display page;
in response to triggering on a group display control in the query region, displaying a group setting window; and
in response to setting on groups in the group setting window, displaying data in the data detail region according to set groups, each of the groups having a data detail sub-region corresponding to the group.

The operation step control may be regarded as a control that triggers display of an operation step for the data display page. The group display control may be considered as a control that triggers a display group setting window. The group setting window may be a setting window for grouping data in the data detail region.

In response to the triggering on the operation control 20 in the query region 17 shown in FIG. 11, a window may be slid on the right side of the data display page, and the operation steps for the data display page are displayed in the window. The operation step for the data display page may be a step performed in the data display page recorded in history, such as a click operation on the data sampling control recorded in history, or a click operation on the group display control.

In response to a triggering on the group display control 19 in the query region 17 shown in FIG. 11, a group setup window is displayed. The group setting window may be displayed to the right side of the data display page, or may be centrally displayed to the upper layer of the data display page, which is not limited herein.

In response to the setting operation on the group in the group setting window, the data in the data detail region is displayed according to the set group, and each group corresponds to the data detail sub-region of the group. The setting operation on the group may be an operation of setting a basis for grouping and displaying a group.

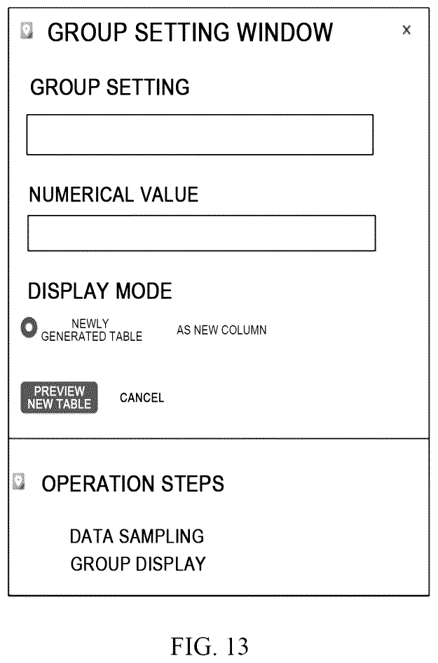

FIG. 13 is a schematic diagram of a group setting window according to an embodiment of the present disclosure. As shown in FIG. 13, an input box corresponding to a group setting and a value is displayed in a group setting window, and a grouping basis may be set by responding to an input operation of an input box. For example, a field for implementing a group may be set by setting an input box corresponding to the group; and a value for implementing the group may be set through an input box corresponding to the value, for example, data set to exceed the set value is divided into one group, and the rest of the data is grouped into one group. The group setting window further displays a display mode, and by setting the display mode, whether the grouped data is a newly generated table or a new column is indicated.

The group setting window shown in FIG. 13 may further display an operation step for the data display page, for example, a click on the data sampling control or a click operation on the group display control as recorded in history.

In the embodiments of the present disclosure, by performing the setting operation on the group, it is convenient to convert the data from the original form into a standard data format, so as to support subsequent data analysis.

According to the embodiment of the invention, data exploration is realized in a visual mode, the threshold of the data exploration operation is reduced, after a result is conveniently detected, the data is converted into a standard data format; the data is intercepted from the number-bin through a perfect sampling strategy, the exploration data is reduced to a certain range as much as possible, the probe response rate is improved, and the waiting time of the data query is shortened.

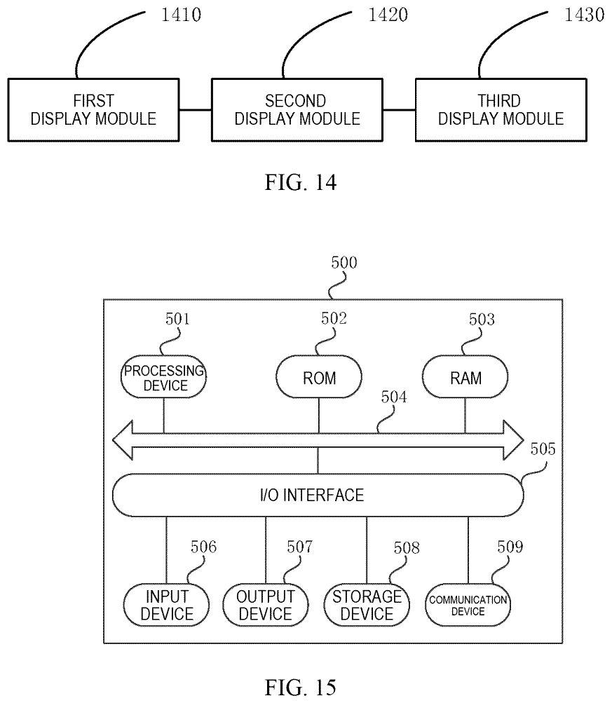

FIG. 14 is a schematic structural diagram of an apparatus for processing data according to an embodiment of the present disclosure. As shown in FIG. 14, the apparatus comprises: a first display module 1410, a second display module 1420, and a third display module 1430.

The first display module 1410 is configured to display a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;

The second display module 1420 is configured to, in response to selection of a target data detail sub-region on the data display page, move a data summary sub-region corresponding to the target data detail sub-region to a first target position, the first target position being a position on the data summary region, corresponding to a position of the target data detail sub-region; and

The third display module 1430 is configured to, in response to selection of a target data summary sub-region on the data display page, move a data detail sub-region corresponding to the target data summary sub-region to a second target position, the second target position being a position on the data detail region, corresponding to a position of the target data summary sub-region.

According to the technical scheme provided by the embodiment of the invention, a data display page is displayed through a first display module, the data display page comprises a data detail region and a data summary region, the data detail region comprises a plurality of data detail sub-regions, and each data detail sub-region is used for displaying data of a corresponding attribute of the data detail sub-region; the data summary region comprises a plurality of data summary sub-regions, and each data summary sub-region is used for displaying summary information of data in a data detail sub-region with the same attribute as the data summary sub-region; in response to a selection of a target data detail sub-region on the data display page, the second display module moves the data summary sub-region corresponding to the target data detail sub-region to a first target position, and the first target position is a position on the data summary region, corresponding to the position of the target data detail sub-region; and in response to the selection of the target data summary sub-region on the data display page, the third display module moves the data detail sub-region corresponding to the target data summary sub-region to a second target position, and the second target position is a position on the data detail region, corresponding to the target data summary sub-region. According to the scheme, the display form of the data exploration result is enriched, the result of data exploration is clearly and visually displayed, and then the characteristic of the data is completely reflected.

In an embodiment, data in the data detail region is displayed in a form of a table, and an attribute to which the data belongs is a field of the table;

The second display module 1420 is specifically configured for:
in response to selection of a field name in the target data detail sub-region on the data display page, moving a data summary sub-region corresponding to the target data detail sub-region to the first target position, the moved data summary sub-region and the target data detail sub-region being aligned to be displayed on the data display page.

In an embodiment, the target data summary sub-region in the data summary region is displayed in a form of a card, and the moved data detail sub-region and the target data summary sub-region are aligned to be displayed on the data display page.

In an embodiment, the summary information indicates a dimension of a summary comprising at least one of:
a zero value in the data, a null value in the data, an enumerated value in the data, or a statistical result of the data.

In an embodiment, the apparatus further comprises:
a first switching module configured for: in response to switching of the data summary sub-region within the data summary region, switching the displayed data summary sub-region within the data summary region, a display position of the data detail sub-region displayed within the data detail region being unchanged; and
a second switching module configured for: in response to switching of the data detail sub-region within the data detail region, switching the displayed data detail sub-region in the data detail region, a display position of the data summary sub-region displayed in the data detail region being unchanged.

In an embodiment, a region width of the data summary sub-region along a moving direction is greater than a region width of the data detail sub-region along a moving direction, and the moving direction of the data summary sub-region is the same as the moving direction of the data detail sub-region.

In an embodiment, the apparatus further comprises:
a size adjusting module configured for: in response to an adjusting operation on a size of the data summary sub-region, adjusting the size of the data summary sub-region.

In an embodiment, the size adjusting module is specifically configured for:
in response to the adjustment operation on the size of the data summary sub-region, adjusting a region width of the data summary sub-region along a moving direction of the data summary sub-region.

In an embodiment, the apparatus further comprises:
a sampling range selection module configured for: in response to selection of a sampling range on a data sampling selection page, sampling data in a database according to a selected sampling range, to obtain data displayed in the data display page.

In an embodiment, sampling range comprises: continuous sampling, filtering sampling and random sampling;
the continuous sampling is configured to retrieve continuous data from the database;
the filtering sampling is configured to retrieve data from the database according to a filter condition; and
the random sampling is configured to randomly retrieve data from the database.

In an embodiment, each of the data summary sub-regions comprises a suggestion control, and the method further comprises:
a suggestion window display module configured for: in response to triggering on a target suggestion control, displaying a suggestion window, subsequent suggestion information on the data corresponding to the data summary sub-region where the target suggestion control is located being displayed on the suggestion window; and
a implementing module configured for: in response to triggering of a configuration control on the suggestion window, implementing a suggestion indicated by the subsequent suggestion information.

In an embodiment, the apparatus further comprises:
a first triggering module configured for: in response to triggering on a hiding control on the data display page, hiding the data summary area on the data display page; and
a second triggering module configured for: in response to triggering on a display control on the data display page, displaying the hidden data summary area on the data display page.

In an embodiment, the data display page comprises:
a query region configured to adjust display states of the data summary area and the data detail area.

In an embodiment, the apparatus further comprises:
a third triggering module configured for: in response to triggering on an operation step control in the query region, displaying an operation step for the data display page;
a fourth triggering module configured for: in response to triggering on a group display control in the query region, displaying a group setting window; and
a group setting module configured for: in response to setting on groups in the group setting window, displaying data in the data detail region according to set groups, each of the groups having a data detail sub-region corresponding to the group.

The apparatus for processing data provided in the embodiments of the present disclosure may perform the data communication method provided in any embodiment of the present disclosure, and has corresponding functional modules and beneficial effects of performing the signaling negotiation method.

It should be noted that the units and modules comprised in the foregoing apparatus are only divided according to the function logic, but are not limited to the foregoing division, as long as the corresponding functions can be implemented. In addition, the specific names of the functional units are merely for ease of distinguishing, and are not intended to limit the protection scope of the embodiments of the present disclosure.

FIG. 15 is a schematic structural diagram of an electronic device according to an embodiment of this disclosure. Reference now is made with FIG. 15, which is a schematic structural diagram of an electronic device (such as the terminal device or server in FIG. 15) 500 suitable for implementing the embodiments of the disclosure.

There is provided an electronic device, comprising:
one or more processing devices;
a storage device storing one or more programs;
the one or more programs, when executed by the one or more processing devices, causes the one or more processing devices implement the method for processing data according to embodiment of this disclosure.

The terminal device in the embodiments of the disclosure may comprise, but not limited to, a mobile terminal such as a mobile phone, a notebook computer, a digital broadcast receiver, a PDA (personal digital assistant), a PAD (portable Android device), a PMP (portable media player), an in-vehicle terminal (for example, an in-vehicle navigation terminal), and a fixed terminal such as a digital TV, a desktop computer, or the like. The electronic device shown in FIG. 15 is merely an example, and should not impose any limitation on the functionality and scope of use of the embodiments of the disclosure.

As shown in FIG. 15, the electronic device 500 may include a processing device (for example, a central processing unit, a graphics processor, etc.) 501, and the processing device 501 may perform various appropriate actions and processing according to a program stored in a read-only memory (ROM) 502 or a program loaded into a random access memory (RAM) 503 from a storage device 505. In the RAM 503, various programs and data required by the operation of the electronic device 500 are also stored. The processing device 501, the ROM 502, and the RAM 505 are connected to each other through a bus 504. An edit/output (I/O) interface 505 is also connected to the bus 504.

Generally, the following devices may be connected to the I/O interface 505: an input device 506 including, for example, a touch screen, a touch pad, a keyboard, a mouse, a camera, a microphone, an accelerometer, a gyroscope, and the like; an output device 507 including, for example, a liquid crystal display (LCD), a speaker, a vibrator, and the like; a storage device 505 including, for example, a magnetic tape, a hard disk, and the like; and a communication device 509. The communication device 509 may allow the electronic device 500 to communicate wirelessly or wired with other devices to exchange data. While FIG. 15 shows an electronic device 500 having various devices, it should be understood that it is not required to implement or have all illustrated devices. More or fewer devices may alternatively be implemented or provided.

In particular, according to an embodiment of this disclosure, the process described above with reference to the flowchart may be implemented as a computer software program. For example, embodiments of the disclosure comprise a computer program product comprising a computer program embodied on a non-transitory computer readable medium, the computer program comprising program code for performing a method shown in flowchart. In such embodiments, the computer program may be downloaded and installed from the network through the communication device 509, or installed from the storage device 505, or from the ROM 502. When the computer program is executed by the processing device 501, the foregoing functions defined in the method of the embodiments of the present disclosure are performed.

The names of messages or information interacted between a plurality of devices in embodiments of the present disclosure are for illustrative purposes only, and are not intended to limit the scope of such messages or information.

The electronic device provided by the embodiments of the disclosure and the data communication method provided in the foregoing embodiments belong to the same inventive concept, and technical details not described in detail in this embodiment may refer to the foregoing embodiments, and this embodiment has the same beneficial effects as the foregoing embodiments.

An embodiment of the present disclosure provides a computer storage medium, having a computer program stored thereon, where the computer program, when executed by a processor, implements the method for processing data provided in the foregoing embodiments.

It should be noted that the computer readable medium described above may be a computer readable signal medium, or a computer readable storage medium, or a combination of the both.

The computer storage media can be storage media for computer executable instructions, which, when executed by a computer processor, are used to perform methods as provided in this disclosure.

The computer-readable storage medium may be, for example, but not limited to, an electrical, magnetic, optical, electromagnetic, infrared, or semiconductor system, apparatus, or device, or a combination thereof. Examples of the computer-readable storage medium may comprise, but not limited to: an electrical connection having one or more wires, a portable computer diskette, a hard disk, a random access memory (RAM), a read-only memory (ROM), an erasable programmable read-only memory (such as an electronic programmable read-only memory (EPROM) or flash memory), an optical fiber, a portable compact disc read-only memory (CD-ROM), an optical storage device, a magnetic storage device, or a suitable combination thereof. In the disclosure, a computer-readable storage medium may be a tangible medium containing or storing a program that may be used by or in connection with an instruction execution system, apparatus, or device. In the disclosure, a computer readable signal medium may comprise a data signal propagated in baseband or as part of a carrier, where the computer readable program code is carried. Such propagated data signals may take a variety of forms, comprising but not limited to electromagnetic signals, optical signals, or suitable combinations thereof. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, comprising but not limited to wires, optical cables, RF (radio frequency), and the like, or suitable combinations thereof.

In some implementations, the client, server may communicate using any currently known or future developed network protocol, such as HTTP (Hypertext Transfer Protocol), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as currently known or future developed networks.

The computer-readable medium described above may be comprised in the electronic device; or may be separately present without being assembled into the electronic device.

The computer readable medium carries one or more programs, and when one or more programs is executed by the electronic device, the electronic device is caused for: displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region; in response to selection of a target data detail sub-region on the data display page, moving a data summary sub-region corresponding to the target data detail sub-region to a first target position, the first target position being a position on the data summary region, corresponding to a position of the target data detail sub-region; and in response to selection of a target data summary sub-region on the data display page, moving a data detail sub-region corresponding to the target data summary sub-region to a second target position, the second target position being a position on the data detail region, corresponding to a position of the target data summary sub-region.

Computer program code for performing the operations of the present disclosure may be written in one or more programming languages, including, but not limited to, object-oriented programming languages such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer involved, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the module does not constitute a limitation on the unit itself in some cases.

The functions described above may be performed, at least in part, by one or more hardware logic components. For example, without limitation, exemplary types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The server-readable medium may be a server-readable signal medium or a server-readable storage medium. The server-readable medium may comprise electronic, magnetic, optical, electromagnetic, infrared, or semiconductor systems, apparatus, or devices, or any suitable combination of the foregoing. The examples of server-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of this disclosure, Example 1 provides a method for processing data, comprising:
displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
in response to selection of a target data detail sub-region on the data display page, moving a data summary sub-region corresponding to the target data detail sub-region to a first target position, the first target position being a position on the data summary region, corresponding to a position of the target data detail sub-region; and
in response to selection of a target data summary sub-region on the data display page, moving a data detail sub-region corresponding to the target data summary sub-region to a second target position, the second target position being a position on the data detail region, corresponding to a position of the target data summary sub-region.

According to one or more embodiments of this disclosure, the method of Example 2 according to Example 1,
data in the data detail region is displayed in a form of a table, and an attribute to which the data belongs is a field of the table;
in response to the selection of the target data detail sub-region on the data display page, moving the data summary sub-region corresponding to the target data detail sub-region to the first target position comprises:
in response to selection of a field name in the target data detail sub-region on the data display page, moving a data summary sub-region corresponding to the target data detail sub-region to the first target position, the moved data summary sub-region and the target data detail sub-region being aligned to be displayed on the data display page.

According to one or more embodiments of this disclosure, the method of Example 3 according to Example 1,
the target data summary sub-region in the data summary region is displayed in a form of a card, and the moved data detail sub-region and the target data summary sub-region are aligned to be displayed on the data display page.

According to one or more embodiments of this disclosure, the method of Example 4 according to Example 1,
the summary information indicates a dimension of a summary comprising at least one of:
a zero value in the data, a null value in the data, an enumerated value in the data, or a statistical result of the data.

According to one or more embodiments of this disclosure, the method of Example 5 according to Example 1, further comprising:
in response to switching of the data summary sub-region within the data summary region, switching the displayed data summary sub-region within the data summary region, a display position of the data detail sub-region displayed within the data detail region being unchanged; and
in response to switching of the data detail sub-region within the data detail region, switching the displayed data detail sub-region in the data detail region, a display position of the data summary sub-region displayed in the data detail region being unchanged.

According to one or more embodiments of this disclosure, the method of Example 6 according to Example 1,
a region width of the data summary sub-region along a moving direction is greater than a region width of the data detail sub-region along a moving direction, and the moving direction of the data summary sub-region is the same as the moving direction of the data detail sub-region.

According to one or more embodiments of this disclosure, the method of Example 7 according to Example 1, further comprising:
in response to an adjusting operation on a size of the data summary sub-region, adjusting the size of the data summary sub-region.

According to one or more embodiments of this disclosure, the method of Example 8 according to Example 7,
in response to the adjusting operation on the size of the data summary sub-region, adjusting the size of the data summary sub-region comprises:
in response to the adjustment operation on the size of the data summary sub-region, adjusting a region width of the data summary sub-region along a moving direction of the data summary sub-region.

According to one or more embodiments of this disclosure, the method of Example 9 according to Example 1, further comprising:
in response to selection of a sampling range on a data sampling selection page, sampling data in a database according to a selected sampling range, to obtain data displayed in the data display page.

According to one or more embodiments of this disclosure, the method of Example 10 according to Example 9,
the sampling range comprises: continuous sampling, filtering sampling and random sampling;
the continuous sampling is configured to retrieve continuous data from the database;
the filtering sampling is configured to retrieve data from the database according to a filter condition; and
the random sampling is configured to randomly retrieve data from the database.

According to one or more embodiments of this disclosure, the method of Example 11 according to Example 1,
each of the data summary sub-regions comprises a suggestion control, and the method further comprises:
in response to triggering on a target suggestion control, displaying a suggestion window, subsequent suggestion information on the data corresponding to the data summary sub-region where the target suggestion control is located being displayed on the suggestion window; and
in response to triggering of a configuration control on the suggestion window, implementing a suggestion indicated by the subsequent suggestion information.

According to one or more embodiments of this disclosure, the method of Example 12 according to Example 1, further comprising:
in response to triggering on a hiding control on the data display page, hiding the data summary area on the data display page; and
in response to triggering on a display control on the data display page, displaying the hidden data summary area on the data display page.

According to one or more embodiments of this disclosure, the method of Example 13 according to Example 1,
the data display page comprises:
a query region configured to adjust display states of the data summary area and the data detail area.

According to one or more embodiments of this disclosure, the method of Example 14 according to Example 13, further comprising:
in response to triggering on an operation step control in the query region, displaying an operation step for the data display page;
in response to triggering on a group display control in the query region, displaying a group setting window; and
in response to setting on groups in the group setting window, displaying data in the data detail region according to set groups, each of the groups having a data detail sub-region corresponding to the group.

According to one or more embodiments of this disclosure, Example 15 provides an apparatus for processing data, comprising:
a first display module configured to display a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
a second display module configured to, in response to selection of a target data detail sub-region on the data display page, move a data summary sub-region corresponding to the target data detail sub-region to a first target position, the first target position being a position on the data summary region, corresponding to a position of the target data detail sub-region; and
a third display module configured to, in response to selection of a target data summary sub-region on the data display page, move a data detail sub-region corresponding to the target data summary sub-region to a second target position, the second target position being a position on the data detail region, corresponding to a position of the target data summary sub-region.

According to one or more embodiments of this disclosure, Example 16 provides an electronic device, comprising:
one or more processing devices;
a storage device storing one or more programs;
the one or more programs, when executed by the one or more processing devices, causing the one or more processing devices implement the method for processing data according to any of Examples 1 to 14.

According to one or more embodiments of this disclosure, Example 17 provides a storage medium comprising computer-executable instructions which, when executed by a computer processor, perform the method for processing data according to any of Examples 1 to 14.

The above description is merely an illustration of the preferred embodiments of the present disclosure and the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the technical solution formed by mutually replacing the above features and the technical features have similar functions disclosed (but not limited to) in the present disclosure.

Further, while operations are depicted in a particular order, this should not be understood to require that these operations be performed in the particular order shown or in sequential order. In certain circumstances, multitasking and parallel processing may be advantageous. Likewise, while several specific implementation details are comprised in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method for processing data, comprising:
displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
in response to selection of a target data detail sub-region on the data display page, moving a data summary sub-region corresponding to the target data detail sub-region to a first target position, the first target position being a position on the data summary region, corresponding to a position of the target data detail sub-region; and
in response to selection of a target data summary sub-region on the data display page, moving a data detail sub-region corresponding to the target data summary sub-region to a second target position, the second target position being a position on the data detail region, corresponding to a position of the target data summary sub-region.

2. The method of claim 1, wherein data in the data detail region is displayed in a form of a table, and an attribute to which the data belongs is a field of the table;
in response to the selection of the target data detail sub-region on the data display page, moving the data summary sub-region corresponding to the target data detail sub-region to the first target position comprises:
in response to selection of a field name in the target data detail sub-region on the data display page, moving a data summary sub-region corresponding to the target data detail sub-region to the first target position, the moved data summary sub-region and the target data detail sub-region being aligned to be displayed on the data display page.

3. The method of claim 1, wherein the target data summary sub-region in the data summary region is displayed in a form of a card, and the moved data detail sub-region and the target data summary sub-region are aligned to be displayed on the data display page.

4. The method of claim 1, wherein the summary information indicates a dimension of a summary comprising at least one of:
a zero value in the data, a null value in the data, an enumerated value in the data, or a statistical result of the data.

5. The method of claim 1, further comprising:
in response to switching of the data summary sub-region within the data summary region, switching the displayed data summary sub-region within the data summary region, a display position of the data detail sub-region displayed within the data detail region being unchanged; and
in response to switching of the data detail sub-region within the data detail region, switching the displayed data detail sub-region in the data detail region, a display position of the data summary sub-region displayed in the data detail region being unchanged.

6. The method of claim 1, wherein a region width of the data summary sub-region along a moving direction is greater than a region width of the data detail sub-region along a moving direction, and the moving direction of the data summary sub-region is the same as the moving direction of the data detail sub-region.

7. The method of claim 1, further comprising:
in response to an adjusting operation on a size of the data summary sub-region, adjusting the size of the data summary sub-region.

8. The method of claim 7, wherein in response to the adjusting operation on the size of the data summary sub-region, adjusting the size of the data summary sub-region comprises:
in response to the adjustment operation on the size of the data summary sub-region, adjusting a region width of the data summary sub-region along a moving direction of the data summary sub-region.

9. The method of claim 1, further comprising:
in response to selection of a sampling range on a data sampling selection page, sampling data in a database according to a selected sampling range, to obtain data displayed in the data display page.

10. The method of claim 9, wherein the sampling range comprises: continuous sampling, filtering sampling and random sampling;
the continuous sampling is configured to retrieve continuous data from the database;
the filtering sampling is configured to take data from the database according to a filter condition; and
the random sampling is configured to randomly take data from the database.

11. The method of claim 1, wherein each of the data summary sub-regions comprises a suggestion control, and the method further comprises:
in response to triggering on a target suggestion control, displaying a suggestion window, subsequent suggestion information on the data corresponding to the data summary sub-region where the target suggestion control is located being displayed on the suggestion window; and
in response to triggering of a configuration control on the suggestion window, implementing a suggestion indicated by the subsequent suggestion information.

12. The method of claim 1, further comprising:
in response to triggering on a hiding control on the data display page, hiding the data summary region on the data display page; and
in response to triggering on a display control on the data display page, displaying the hidden data summary region on the data display page.

13. The method of claim 1, wherein the data display page comprises:
a query region configured to adjust display states of the data summary region and the data detail region.

14. The method of claim 13, further comprising:
in response to triggering on an operation step control in the query region, displaying an operation step for the data display page;
in response to triggering on a group display control in the query region, displaying a group setting window; and
in response to setting on groups in the group setting window, displaying data in the data detail region according to set groups, each of the groups having a data detail sub-region corresponding to the group.

15. An electronic device, comprising:
one or more processing devices;
a storage device storing one or more programs;
the one or more programs, when executed by the one or more processing devices, causing the one or more processing devices implement acts comprising:
displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
in response to selection of a target data detail sub-region on the data display page, moving a data summary sub-region corresponding to the target data detail sub-region to a first target position, the first target position being a position on the data summary region, corresponding to a position of the target data detail sub-region; and
in response to selection of a target data summary sub-region on the data display page, moving a data detail sub-region corresponding to the target data summary sub-region to a second target position, the second target position being a position on the data detail region, corresponding to a position of the target data summary sub-region.

16. The electronic device of claim 15, wherein data in the data detail region is displayed in a form of a table, and an attribute to which the data belongs is a field of the table;
in response to the selection of the target data detail sub-region on the data display page, moving the data summary sub-region corresponding to the target data detail sub-region to the first target position comprises:
in response to selection of a field name in the target data detail sub-region on the data display page, moving a data summary sub-region corresponding to the target data detail sub-region to the first target position, the moved data summary sub-region and the target data detail sub-region being aligned to be displayed on the data display page.

17. The electronic device of claim 15, wherein the target data summary sub-region in the data summary region is displayed in a form of a card, and the moved data detail sub-region and the target data summary sub-region are aligned to be displayed on the data display page.

18. The electronic device of claim 15, wherein the summary information indicates a dimension of a summary comprising at least one of:
a zero value in the data, a null value in the data, an enumerated value in the data, or a statistical result of the data.

19. The electronic device of claim 15, the acts further comprising:
in response to switching of the data summary sub-region within the data summary region, switching the displayed data summary sub-region within the data summary region, a display position of the data detail sub-region displayed within the data detail region being unchanged; and
in response to switching of the data detail sub-region within the data detail region, switching the displayed data detail sub-region in the data detail region, a display position of the data summary sub-region displayed in the data detail region being unchanged.

20. A non-transitory storage medium comprising computer-executable instructions which, when executed by a computer processor, perform the method for processing data comprising:
displaying a data display page, the data display page comprising a data detail region and a data summary region, the data detail region comprising a plurality of data detail sub-regions, and each of the data detail sub-regions displaying data of an attribute corresponding to the data detail sub-region; the data summary region comprising a plurality of data summary sub-regions, and each of the data summary sub-regions displaying summary information of data in the data detail sub-region having a same attribute as the data summary sub-region;
in response to selection of a target data detail sub-region on the data display page, moving a data summary sub-region corresponding to the target data detail sub-region to a first target position, the first target position being a position on the data summary region, corresponding to a position of the target data detail sub-region; and
in response to selection of a target data summary sub-region on the data display page, moving a data detail sub-region corresponding to the target data summary sub-region to a second target position, the second target position being a position on the data detail region, corresponding to a position of the target data summary sub-region.
